(19) United States
(12) Patent Application Publication
(10) Pub. No.: US 2014/0139785 A1
(43) Pub. Date: May 22, 2014

(54) TWO-WAY DISPLAY DEVICE AND METHOD OF DRIVING THE SAME

(71) Applicant: Samsung Display Co., LTD., Yongin-City (KR)

(72) Inventors: Joo-Hyuk PARK, Asan-si (KR); Moon-Shik KANG, Yongin-si (KR); Jeong-Jin PARK, Cheonan-si (KR); Han-Yul YU, Asan-si (KR); Su-Young YUN, Asan-si (KR); Kyung-Won LEE, Gwangmyeong-si (KR)

(21) Appl. No.: 13/910,453

(22) Filed: Jun. 5, 2013

(30) Foreign Application Priority Data
Nov. 21, 2012 (KR) 10-2012-0132260

(51) Int. Cl. G02F 1/1335

(52) U.S. Cl. CPC G02F 1/133606
USPC 349/62

(57) ABSTRACT

A two-way display device includes a transparent display panel, a roll film unit disposed opposite to the transparent display panel and a backlight unit disposed between the roll film unit and the transparent display panel.

This application claims priority to Korean Patent Application No. 10-2012-0132260, filed on Nov. 21, 2012, and all benefits accruing therefrom under 35 U.S.C. §119, the content of which in its entirety is herein incorporated by reference.

### BACKGROUND

1. Field

Exemplary embodiments of the invention relate to a two-way display device and a method of driving the two-way display device. More particularly, exemplary embodiments of the invention relate to a two-way display device with reduced light leakage by reusing light that leaks to an opposite side from a user, and a method of driving the two-way display device.

2. Description of the Related Art

A liquid crystal display (“LCD”) device is a display device that displays an image by applying voltages to specific molecules of liquid crystal to convert arrangements of the molecules and change optical characteristics of the liquid crystal cell, such as birefringence, optical activity, dichroism and light scattering, for example.

Generally, the liquid crystal display device may not emit light by itself, and the LCD device typically includes an external light source. A transparent display device typically has a low visibility when an external light source is not provided, and a user may not observe an image on the transparent display device when the external light source is not provided, for example, during the nighttime. Accordingly, the transparent display device that does not include a backlight unit may be used only during the daytime when the light source such as sunlight exists.

A backlight unit supplies light to display an image on a liquid crystal display panel. A transparent backlight unit including a transparent light guide plate may be included in the transparent display device to maintain the transparency thereof. When a transparent backlight unit is combined with the transparent display panel, the transparent backlight unit may not be driven during the daytime when intensity of surrounding light thereof is substantially high to reduce electric power consumption. The transparent backlight unit may be adapted in the transparent display device to effectively display an image during the nighttime. However, The transparent backlight unit may not include a reflector, which is typically attached on a backside of a light guide plate, to maintain the transparency of the transparent display device.

### SUMMARY

One or more exemplary embodiment of the invention provides a two-way display device including a transparent display panel, a backlight unit, a roll film unit and a display panel driving circuit. In such embodiments, the two-way display device recycles light emitted from the backlight unit to an opposite side of the transparent display panel.

One or more exemplary embodiment of the invention also provides a method of driving the above-mentioned two-way display device.

According to an exemplary embodiment of the invention, a two-way display device includes a transparent display panel, a roll film unit disposed opposite to the transparent display panel and a backlight unit disposed between the roll film unit and the transparent display panel.

In an exemplary embodiment, the two-way display device may further include a display panel driving circuit unit which drives the transparent display panel and a controller which controls the display panel driving circuit unit.

In an exemplary embodiment, the two-way display device may further include a roll film driving circuit unit which drives the roll film.

In an exemplary embodiment, the two-way display device may further include a light sensor which senses an intensity of illumination.

In an exemplary embodiment, the two-way display device may further include a light source driving circuit unit which drives the backlight unit.

In an exemplary embodiment, the roll film unit may include a film portion which displays an image and a roller which moves the film portion.

In an exemplary embodiment, the film portion may include an image region which displays a fixed image.

In an exemplary embodiment, the film portion may further include at least one of a transparent film region and a reflective film region

In an exemplary embodiment, the film portion may include an image portion disposed in the middle of the film and a plurality of holes defined therein and arranged along a side of the film portion at predetermined intervals.

In an exemplary embodiment, the roller may include protrusions disposed on an external surface of the roller at regular intervals.

In an exemplary embodiment, the backlight unit may include a light source disposed on a side of the backlight unit and a light guide plate which disperses light from the light source toward the transparent display panel and the roll film unit.

In an exemplary embodiment, the backlight unit may further include a plurality of optical sheets which disperses light emitted from the light guide plate.

In an exemplary embodiment, the light source may be a light emitting diode.

In an exemplary embodiment, the light guide plate may include a light dispersing agent.

In an exemplary embodiment, the light dispersing agent may include at least one selected from a cross-linkage or noncross-linkage particle of silicon, acryl, styrene, methyl methacrylate-styrene copolymer, polycarbonate, butylacrylate, and olefin, silica, talc, calcium carbonate, barium sulfate and titanium dioxide.

According to another exemplary embodiment of the invention, a method of driving two-way display device includes sensing surrounding light of the two-way display device, where the two-way display device includes: a transparent display panel; a roll film unit disposed opposite to the transparent display panel; and a backlight unit disposed between the roll film unit and the transparent display panel, where the roll film unit comprises an image region, a transparent film region and a reflective film region; analyzing the surrounding light to measure an intensity of illumination; and disposing one of the image region, the transparent film region and the reflective film region to face the backlight unit based on the measured intensity of illumination by driving the roll film unit.

In an exemplary embodiment, the disposing one of the image region, the transparent film region and the reflective film region to face the backlight unit include disposing the transparent film region to face the backlight unit when the measured intensity of illumination is greater than a predetermined intensity.

In an exemplary embodiment, the method of driving two-way display device may further include driving the backlight unit to provide light to the transparent display panel and the roll film when the measured intensity of illumination is less than a predetermined intensity.

In an exemplary embodiment, the disposing one of the image region, the transparent film region and the reflective film region to face the backlight unit may include the image region to face the backlight unit when the measured intensity of illumination is less than the predetermined intensity.

In an exemplary embodiment, the disposing one of the image region, the transparent film region and the reflective film region to face the backlight unit may include the reflective film region to face the backlight unit when the measured intensity of illumination is less than the predetermined intensity.

According to exemplary embodiments of the invention, a two-way display device includes a transparent display panel, a backlight unit, a roll film unit and a display panel driving circuit unit. In such embodiment, the backlight unit may be a transparent backlight unit, and the roll film unit is disposed on the backside of the transparent display panel. Accordingly, light from a light source, which is emitted from the backlight unit to the backside of the transparent display panel, might be recycled, such that brightness of the transparent display panel is substantially increased.

In such embodiments, the two-way display device may decrease a light leakage, such that electric power consumption by driving the backlight unit may be substantially minimized or effectively prevented.

### BRIEF DESCRIPTION OF THE DRAWINGS

The above and other features of the invention will become more apparent by describing in detailed exemplary embodiments thereof with reference to the accompanying drawings, in which:

FIG. 1 is a block diagram illustrating an exemplary embodiment of two-way display device according to the invention;

FIG. 2 is a cross-sectional view illustrating an exemplary embodiment of two-way display device of FIG. 1;

FIG. 3 is a top plan view illustrating an exemplary embodiment of a film portion of a roll film unit shown in FIG. 2;

FIG. 4 is a cross-sectional view illustrating an exemplary embodiment of a backlight unit of FIG. 1;

FIG. 5 is a block diagram illustrating an exemplary embodiment of a driving method of a two-way display device.

### DETAILED DESCRIPTION

The invention will be described more fully hereinafter with reference to the accompanying drawings, in which exemplary embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments will be described in detail with reference to the accompanying drawings.

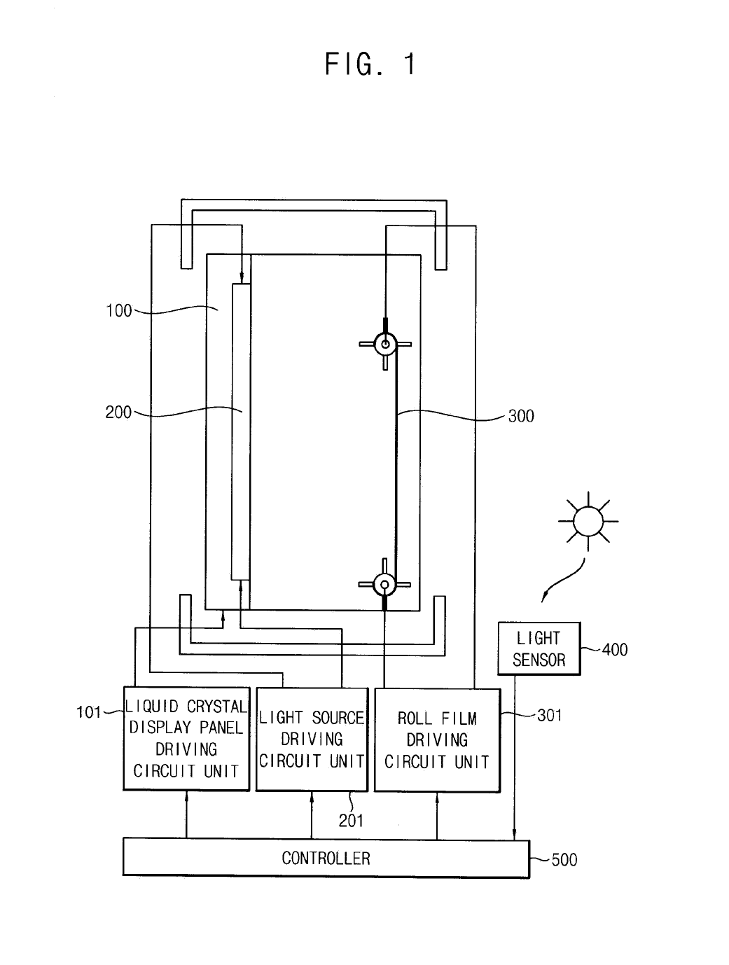

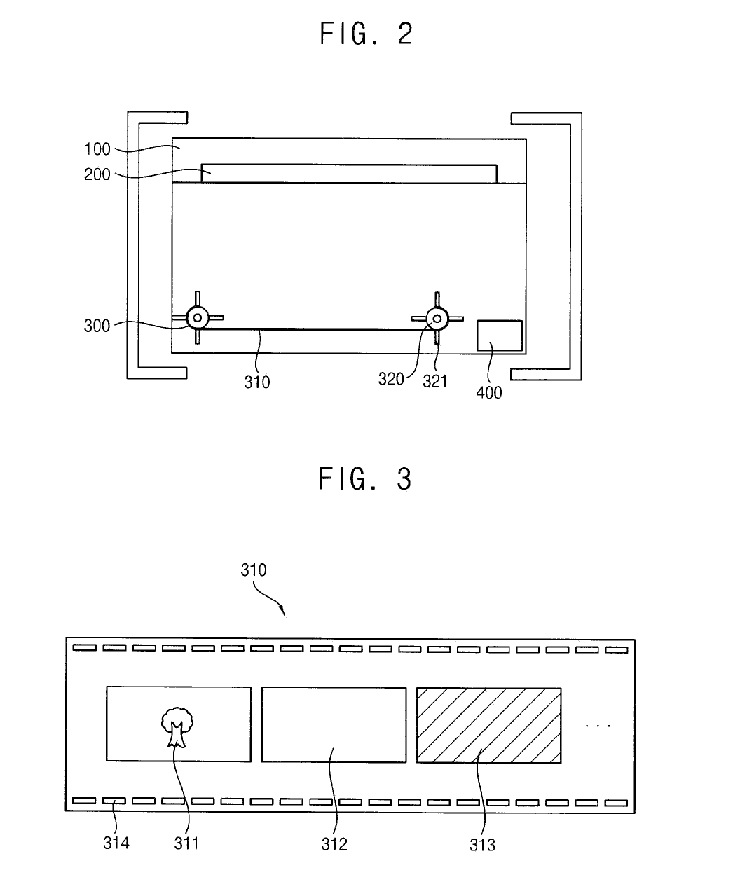

FIG. 1 is a block diagram illustrating an exemplary embodiment of a two-way display device according to the invention. FIG. 2 is cross-sectional view illustrating an exemplary embodiment of the two-way display device in FIG. 1.

Referring to FIGS. 1 and 2, an exemplary embodiment of two-way display device the invention includes a transparent display panel 100, a roll film unit 300 disposed opposite to, e.g., facing, the transparent display panel 100, and a backlight unit 200 disposed between the roll film unit 300 and the transparent display panel 100.

The two-way display device may further include a display panel driving circuit unit 101 that drives the transparent display panel and a controller 500 that controls the display panel driving circuit unit to display an image, a roll film driving circuit unit 301 that drives the roll film unit 300, a light sensor 400 that senses an intensity of illumination, and a light source driving circuit unit that drives the backlight unit.

The transparent display panel 100 is disposed on a first side of the backlight unit 200. The transparent display panel 100 displays an image. The transparent display panel 100 may include a first substrate, a second substrate, a liquid crystal (“LC”) layer, a gate driving unit and a data driving unit.

The first substrate and the second substrate may be a transparent insulation substrate. In an exemplary embodiment, the transparent insulation substrate may be a glass substrate or a plastic substrate, for example.

The first substrate may be a thin film transistor substrate including a plurality of thin film transistors (“TFT”s). In an exemplary embodiment, the TFTs of the thin film transistor substrate may be arranged substantially in a matrix form. The first substrate may include a plurality of gate lines and a plurality of data lines, which are connected to the TFTs.

The liquid crystal LC layer is disposed between the first substrate and the second substrate. The second substrate is disposed opposite to, e.g., facing, the first substrate. The second substrate may be a color filter substrate. The color filter substrate converts light which is incident from the backlight unit 200, to have a predetermined color. The second substrate may include a first color filter, a second color filter and a third color filter. The second substrate may further include a black matrix, which is disposed between the first to third color filters.

In one exemplary embodiment, for example, the first color filter may be a red color filter, the second color filter may be a green color filter, and the third color filter may be a blue color filter.

The first color filter, the second color filter and the third color filter may be arranged sequentially or repeatedly in a row direction or in a column direction. Each of the color filters may be one of a red color filter, a green color filter and a blue color filter, but not being limited thereto. In an alternative exemplary embodiment, for example, each of the color filters may be one of a cyan color filter, a magenta color filter, a yellow color filter and a white color filter.

In an exemplary embodiment, a color filter and a pixel electrode may be provided, e.g., formed, together on the first substrate. In an alternative exemplary embodiment, a black matrix and a pixel electrode may be provided, e.g., formed, together on the first substrate. In such an embodiment, a color filter may be provided, e.g., formed, together with the black matrix and the pixel electrode on the first substrate.

The gate driving unit and the data driving unit are connected to the first substrate and outputs driving signals to the first substrate. Each of the gate driving unit and the data driving unit include a flexible printed circuit board (“FPCB”), a driving chip disposed on the FPCB, and a printed circuit board (“PCB”) connected to a side of the FPCB.

The roll film unit 300 faces a second side of the transparent display panel 100, which is opposite to the first side. The second side of the transparent display panel 100 faces the backlight unit 200.

The roll film unit 300 of the two-way display device will be described later in detail with reference to FIG. 3.

The backlight unit 200 may emit light toward the transparent display panel 100 and the roll film unit 300. Accordingly, the two-way display device displays an image in two directions, e.g., a front side corresponding to the transparent display panel 100, and a back side corresponding to the roll film unit 300.

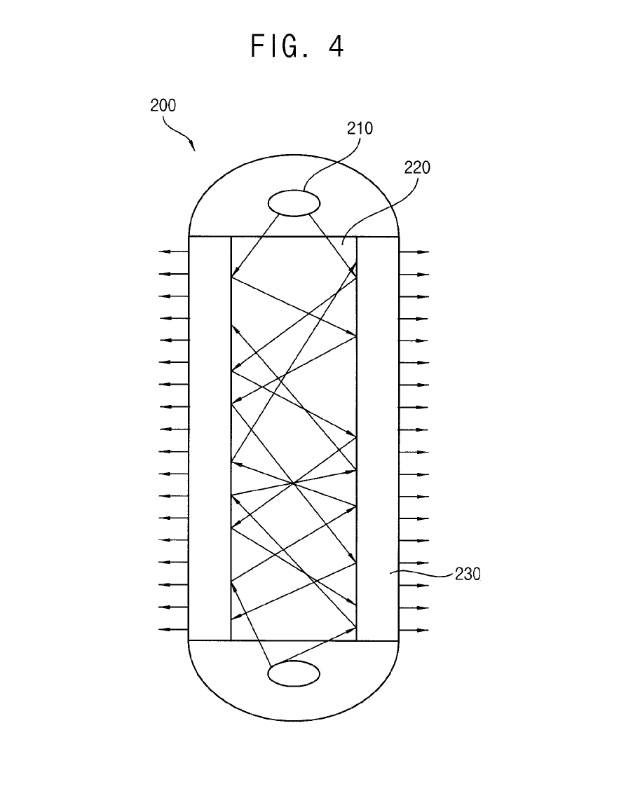

The backlight unit 200 of the two-way display device will be described later in detail with reference to FIG. 4.

The transparent display panel 100 may be driven by the liquid crystal display panel driving circuit unit 101. The transparent display panel 100 may be controlled by the controller 500.

The light source driving circuit unit 201 does not apply a power to a light source 210 by the controller 500 when a measured intensity of illumination is greater than a predetermined intensity. The light source driving circuit 201 apply a power to the light source 210 when the measured intensity is less than a predetermined intensity.

The light sensor 400 may include a light receiver and a lens plate of a prism shape. The light sensor 400 may be disposed on a peripheral area of the transparent display panel 100 and senses surrounding light. The light sensor 400 may be variously modified based on an external light source.

The light sensor 400 collects light from the external light source, e.g., sunlight, and analyzes an intensity of illumination. The light sensor 400 transmits the analyzed intensity to the controller 500.

When light from the backlight unit 200 is supplied to a lower surface of the light sensor 400, noise may occur. The two-way transparent display device may further include a light blocking member, which is disposed on the lower surface of the light sensor 400.

In an exemplary embodiment, the light blocking member may be a driving circuit substrate (not illustrated) that drives the light sensor. In such an embodiment, the driving circuit substrate may be disposed on the lower surface of the light sensor 400, and the driving circuit substrate blocks light from being incident on the lower surface of the light sensor 400.

The light sensor 400 may further include a memory (not illustrated) to control a light source based on the intensity of illumination. A predetermined intensity may be stored as a level zero (0) in the memory. When the measured intensity is the level zero (0), the light source is not driven. When the measured intensity of illumination is greater than the level zero (0), a user may observe an image on the transparent display panel when the light source is not driven.

In such an embodiment, light less than the predetermined intensity may be defined as levels 1, 2, 3 and 4 based on an intensity of illumination. The levels 1, 2, 3 and 4 are stored in the memory, and the controller drives the light source based on the levels of the intensity of illumination. In an exemplary embodiment, the level 1 may be the brightest, and as the level rises from the level 1 to the level 4, the corresponding intensity of illumination becomes lower.

In an exemplary embodiment, the light source is driven and controlled based on the brightness of light surrounding the two-way display device, such that electric power consumption is substantially reduced. In such an embodiment, a roll film portion includes a reflective region which increases brightness of the transparent display device with a relatively less light from the light source in a dark state.

FIG. 3 is a top plan view of an exemplary embodiment of a film portion of a roll film unit in FIG. 2.

Referring to FIGS. 2 to 3, an exemplary embodiment of a roll film unit 300 of the two-way display device according to the invention is disposed opposite to, e.g., facing, the transparent display panel 100. The backlight unit 200 is disposed between the transparent display panel 100 and the roll film unit 300.

The roll film unit 300 includes a film portion 310 that displays an image, and a roller 320 that moves the roll film portion. The film portion 310 may include an image region 311 having a fixed image, and may further include at least one of a transparent film region 312 and a reflective film region 313.

In an exemplary embodiment, as shown in FIG. 3, the image region 311, the transparent film region 312 and the reflective film region 313 are disposed in the middle of the film portion 310. The image region 311, the transparent film region 312 and the reflective film region 313 are arranged along the longitudinal direction of the roll film portion 310.

The image region 311 has an image to be viewed by a user in a backside of the transparent display panel 100.

The image of the image region 311 may display a fixed image such as an advertisement, for example. The image of the image region 311 is disposed on the roll film unit 300 by printing, transcription and development, for example.

In an exemplary embodiment, the roll film unit 300 may further include a plurality of image regions 311 having different images.

The roll film unit 300 drives the image regions 311 to move sequentially. In such an embodiment, the roll film unit 300 may display a plurality of images to the user in the backside of the transparent display panel 100.

The transparent film region 312 of the roll film unit 300 is displayed during the daytime when intensity of surrounding light of the two-way display device is substantially high.

When the transparent film region 312 is displayed in the roll film unit 300, a background of the two-way display device is projected and viewed by a user who sees the transparent display panel 100. Accordingly, an image of the transparent display panel 100 overlaps on the background of the two-way display device.

In such an embodiment, the background of the two-way display device is not projected when the image region 311 or the reflective film region 313 is displayed instead of the transparent film region 312.

In an exemplary embodiment, the backlight unit 200 is driven during the nighttime when intensity of surrounding light of the two-way display device is substantially low. The reflective film region 313 may be disposed on the roll film unit when the transparent display panel 100 displays an image. The reflective film region 313 may face the backlight unit 200.

In such an embodiment, light emitted from the backlight unit 200 to the roll film unit 300 is reflected by the reflective film of the reflective film region 313. The reflected light is recycled as a light source of the transparent display panel 100, such that brightness of the transparent display panel 100 is increased.

In such an embodiment, when the reflective film is disposed facing the backlight unit 200, a current provided to the light source may be reduced to decrease electric power consumption.

In an exemplary embodiment, as described above, the roll film unit 300 includes the image region 311, the transparent film region 312 and the reflective film region 313. In an alternative exemplary embodiment, the roll film unit 300 may include any one or two of the image region 311, the transparent film region 312 and the reflective film region 313.

The film portion 310 includes a plurality of holes 314 that are arranged along a longitudinal side of the film portion 310 at predetermined intervals, e.g., constant or regular intervals. In an exemplary embodiment, the holes 314 may be provided on both opposing longitudinal sides of the film portion 310

A roller 320 includes a protrusion 321 that protrudes to be inserted into the hole 314. The protrusions 321 protrude from an external surface of the roller at predetermined intervals, e.g., constant or regular intervals.

Each of the protrusion 321 of the roller 320 is inserted into a corresponding hole of the holes 314 in the film portion 310 in a direction at predetermined intervals, e.g., regular or constant intervals. The film portion 310 moves in a longitudinal direction of the film portion 310 by a rotation of the roller 320.

FIG. 4 is a cross-sectional view illustrating an exemplary embodiment of the backlight unit 200 in FIG. 1.

Referring to FIGS. 1, 2 and 4, an exemplary embodiment of the backlight unit 200 of the two-way display device according to the invention includes the light source 210 and a light guide plate 220. The light source 210 is disposed on a side of the backlight unit. The light source 210 provides light to the transparent display panel 100 and the roll film unit 300. The light guide plate 220 disperses the light to a substantially entire of a surface of each of the transparent display panel 100 and the roll film unit 300.

In an exemplary embodiment, the backlight unit 200 may further include a plurality of optical sheets that disperses the light emitted from the light guide plate 220.

The backlight unit 200 emits light, and provides the light to the transparent display panel 100 and the roll film unit 300. A first side of the backlight unit 200 faces the second side of the transparent display panel 100.

The light source 210 emits light to display an image. The light is controlled by the light source driving circuit 201. The light is emitted toward the light guide plate 220. In an exemplary embodiment, the backlight unit 200 may include a plurality of light sources 210, and the number of the light sources 210 may vary based on an efficiency of the light sources 210 and the light guide plate 220.

In one exemplary embodiment, for example, the light source 210 may be a point light source or a linear light source. The light source 210 may include at least one of a cold cathode fluorescent lamp (“CCFL”), an external electrode fluorescent lamp (“EEFL”), a flat fluorescent lamp (“FFL”), and a light emitting diode (“LED”), for example.

The light source 210 is driven by the light source driving circuit unit 201 through the controller 500. A power may be applied to the light source 210 by the light source driving circuit 201. In an exemplary embodiment, the light source driving circuit 201 does not apply a power to a light source 210 when a measured intensity of illumination is greater than a predetermined intensity. In such an embodiment, when the measured intensity of illumination is less than a predetermined intensity, a power is applied to the light source 210.

The light guide plate 220 guides the light from the light source 210 to the transparent display panel 100 and the roll film 300. The light guide plate 220 disperses light to be substantially uniform. The light guide plate 220 provides the dispersed light to the transparent display panel 100 and the roll film unit 300. The light guide plate 220 disperses the light to a substantially entire of the surface of each of the transparent display panel 100 and the roll film unit 300.

In an exemplary embodiment, light having a point light optical distribution or a linear light optical distribution is converted into light having a surface light optical distribution by the light guide plate 220. In such an embodiment, the light guide plate 220 converts a light path.

The backlight unit 200 may further include an optical sheet 230 that disperses and emits the light from the light guide plate 220. In one exemplary embodiment, for example, the optical sheet 230 may be disposed between the transparent display panel 100 and the light guide plate 220. In an alternative exemplary embodiment, the optical sheet 230 may be disposed on both sides of the light guide plate 220, such that the diffused light emits toward both sides of the backlight unit 200.

In an exemplary embodiment, the optical sheet 230 may include a plurality of sheets. In one exemplary embodiment, for example, the optical sheet 230 may include a dual brightness enhancement film sheet, a prism sheet and a diffusion sheet.

In such an embodiment, the dual brightness enhancement film sheet may be disposed on an upper surface of the prism sheet. The dual brightness enhancement film sheet may enhance brightness of light which is incident from the prism sheet.

The optical sheet 230 may include the prism sheet that decreases irregularity of light, to thereby improve a front view angle thereof. The prism sheet may include a plurality of prisms that are disposed on an upper surface of the prism sheet. The prism may have a triangular prism shape. The prism sheet may concentrate light which is diffused by the diffusion sheet. The prism sheet may concentrate light substantially in a vertical direction of the transparent display panel 100. In an exemplary embodiment, a protection sheet may be further provided between the dual brightness enhancement film sheet and the prism sheet. The protection sheet may protect a prism sheet from a scratch. In an exemplary embodiment, the prism sheet may include a plurality of sheets. In one exemplary embodiment, for example, the optical sheet may include the dual brightness enhancement film sheet, the prism sheet and the diffusion sheet, but not being limited thereto.

The diffusion sheet may further include a coating layer. The coating layer may include a base substrate and a bead disposed on the base substrate. The diffusion sheet may diffuse light and provides uniformized brightness. The diffusion sheet may have a multi-layered structure.

In an alternative exemplary embodiment, the optical sheet 230 may further include additional sheet other than the dual brightness enhancement film sheet, the prism sheet, the diffusion sheet and the protection sheet. In an exemplary embodiment, the optical sheet 230 may include at least one the sheet. In another alternative exemplary embodiment, the optical sheet 230 may include a multi-function sheet that performs a plurality of functions, e.g., the functions of at least one of the dual brightness enhancement film sheet, the prism sheet, the diffusion sheet and the protection sheet.

In an exemplary embodiment, the light guide plate 220 may include a composition including a transparent resin and a light dispersing agent.

In such an embodiment, the transparent resin has a high optical transmittance and a high durability. The transparent resin may include acrylic resin, styrene-acrylic copolymer resin, styrene resin, styrene-acrylonitrile resin and polycarbonate resin, for example.

The acrylic resin may be a polymer or a copolymer including at least one of methacrylic alkyl esters, such as methymethacrylate, ethylmethacrylate, butylmethacrylate and 2-ethylhexylmethacrylate; acrylic alkyl esters, such as methyacrylate, ethylacrylate and butylacrylate; methacrylic cycloalkyl esters, such as cyclohexyl methacrylate, 2-methylcyclohexyl-methacrylate and dicyclopentanyl-methacrylate; acrylic cycloalkyl esters, such as cyclohexylacrylate; 2-methylcyclohexylacrylate; methacrylic aryl esters, such as phenylmethacrylate, benzylmethacrylate; acrylic aryl ester, such as phenylacrylate and benzylacrylate, for example.

The styrene-acrylic copolymer resin may be a copolymer including at least one of methacrylic alkyl ester, acrylic alkyl ester, methacrylic cycloalkyl ester, acrylic cycloalkyl ester, methacrylic aryl ester and acrylic aryl ester, and at least one of styrene, α-methylstyrene, m-methylstyrene, p-methylstyrene and p-methoxystyrene, for example.

The styrene resin may be a polymer or a copolymer including at least one of styrene, α-methylstyrene, m-methylstyrene, p-methylstyrene and p-methoxystyrene, for example.

The polycarbonate resin may be a polymer or a copolymer including linear or branched aromatic polycarbonate polymer, which is produced by reacting dihydroxy phenol with phosgene or reacting dihydroxy phenol with a precursor of carbonate, polyester copolymer or a mixture thereof.

The light dispersing agent is included to disperse light. The light dispersing agent may include organic particle, inorganic particle or mixture thereof. In one exemplary embodiment, for example, the light dispersing agent may include a cross-linkage or noncross-linkage particle of silicon, acryl, styrene, methyl methacrylate-styrene copolymer, polycarbonate, butylacrylate and olefin, silica, talc, calcium carbonate, barium sulfate, and titanium dioxide.

A diameter of the light dispersing agent is in a range from about 0.5 micrometer (μm) to about 5.0 micrometers (μm). In one exemplary embodiment, for example, the diameter of the light dispersing agent is in a range from about 0.8 μm to about 4 μm. When the diameter of the light dispersing agent is less than, for example, about 0.5 μm, dispersion with a transparent resin may be not only decreased, but also a luminous efficiency may be decreased by decreasing a scattering of light. When the diameter is greater than, for example, about 5 μm, a light dispersing performance may decrease, such that a dispersing of light may not be effectively performed.

An absolute value of a reflective index difference between the light dispersing agent and the transparent resin is, for example, in a range of about 0.1 to about 1.1. When an absolute value is in a range of about 0.1 to about 1.1, the light dispersing agent may allow a light guide plate 220 to have substantially high luminous efficiency, by providing substantial scattering of light.

A concentration of the light dispersing agent may be controlled based on a scale of the light guide plate 220 and a uniformity of a brightness or illumination. The concentration of the light dispersing agent is, for example, about 1 to about 10 weight parts per 100 weight parts with respect to weight of the transparent resin. When the light dispersing agent is less than about 1 weight part with respect to the weight of the transparent resin, an incident light may not disperse efficiently. When the light dispersing agent is greater than about 10 weight parts based on weight of the transparent resin, a transparency of a light transmittance decreases, and brightness may thereby decrease.

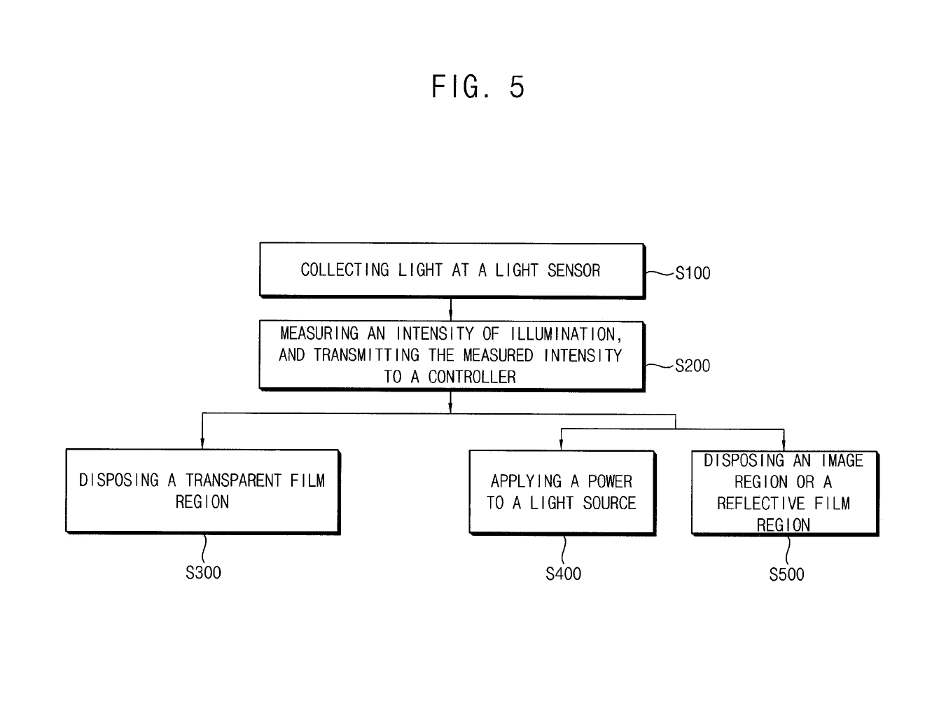

FIG. 5 is a block diagram illustrating an exemplary embodiment of a driving method of two-way display device.

Referring to FIG. 5, an exemplary embodiment of a method of driving a two-way display device according to the invention includes collecting light at a light sensor (S100). The collected light is analyzed, and an intensity of illumination is thereby measured. In such an embodiment, the measured intensity of illumination is transmitted to a controller (S200).

Referring back to FIG. 1, the transparent display panel 100 may be driven by the controller 500 through the display panel driving circuit unit 101. The roll film unit 300 may be driven by the roll film driving circuit unit 301 through the controller 500. The backlight unit 200 may be driven by the light source driving circuit unit 201 through the controller 500.

The controller 500 may control the two-way display device.

The controller 500 may drive the display panel driving circuit unit 101, the light source driving circuit unit 201 and the roll film driving circuit unit 301 based on the measured intensity of illumination transmitted from the light sensor 400.

The controller 500 may drive the transparent display panel 100 through the display panel driving circuit 101, and the transparent display panel 100 thereby displays an image.

The light sensor 400 may collect surrounding light from sunlight and measures an intensity of illumination of the surrounding light. The light sensor 400 may transmit the measured intensity of illumination to the controller 500 based on a predetermined intensity.

When the measured intensity of illumination is greater than the predetermined intensity, the film portion 310 of the roll film unit 300 may be moved such that the transparent film region 312 is disposed to face the backlight unit 200 to provide an external light to the transparent display panel 100 passing through the roll film unit 300 and the backlight unit 200 (S300).

In one exemplary embodiment, for example, the predetermined intensity may be about 300 lux (lx). An intensity of illumination of about 300 lx may be substantially equal to an intensity of a fluorescent light that is about 2 meters away from a specific position. When the measured intensity is greater than 300 lx, a user may see an image on the transparent display panel without driving the backlight unit 200.

When the transparent film region 312 is disposed to face the backlight unit 200, an image on the transparent display panel may be displayed on the background of the transparent display device.

In an exemplary embodiment, when the measured intensity is greater than a predetermined intensity, a user may see an image on the transparent display panel without applying a power to a light source of the backlight unit. When the surrounding light has intensity greater than the predetermined intensity, a user may see an image without driving the backlight unit 200.

When the measured intensity is less than the predetermined intensity, a power is applied to a light source of the backlight unit 200 such that the backlight unit 200 may provide light to the transparent display panel 100 and the roll film unit 300 (S400).

In such an embodiment, when the backlight unit 200 is driven, the film portion 310 of the roll film unit 300 may be moved such that the image region 311 may be disposed to face the backlight unit 200 (S500).

In an exemplary embodiment, when the measured intensity is less than a predetermined intensity, a user may not observe an image on the transparent display panel without applying a power to the light source of the backlight unit 200. When the surrounding light has intensity greater than the predetermined intensity, a user may not see an image.

A user may see an image on the transparent display panel with light emitted from the backlight unit 200. Another user, who sees the backside of the transparent display panel, may see an image on the image region 311 of the roll film unit 300.

In an exemplary embodiment, when the measured intensity is less than the predetermined intensity, the film portion 310 of the roll film unit 300 may be moved such that the reflective film region 313 may be disposed to face the backlight unit (S500). In such an embodiment, the reflective film region 313 may be disposed to face the backlight unit while the backlight unit is driven.

In such an embodiment, the reflective film of the reflective film region 313 may functions as a reflector. In such an embodiment, the reflective film reflects light which is emitted from the backlight unit 200. The reflected light is provided to the transparent display panel 100. In such an embodiment, the light which is emitted from the backlight unit may be effectively prevented from being absorbed in the roll film unit, thereby substantially minimizing a light leakage. Thus, the light which emits toward the roll film unit may be recycled at the transparent display panel 100.

Accordingly, in an exemplary embodiment, a leakage of light which emits from the backlight unit 200 may be substantially minimized such that brightness of the transparent display device is substantially increased.

In an exemplary embodiment, when the reflective film is disposed to face the backlight unit 200, an amount of light provided to the transparent display panel 100 may be increased, such that electric power consumption by the light source 210 may be decreased.

The foregoing is illustrative of the invention and is not to be construed as limiting thereof. Although a few example embodiments of the invention have been described, those skilled in the art will readily appreciate that many modifications are possible in the example embodiments without materially departing from the novel teachings and advantages of the invention. Accordingly, all such modifications are intended to be included within the scope of the invention as defined in the claims. Therefore, it is to be understood that the foregoing is illustrative of the invention and is not to be construed as limited to the specific example embodiments disclosed, and that modifications to the disclosed example embodiments, as well as other example embodiments, are intended to be included within the scope of the appended claims. The invention is defined by the following claims, with equivalents of the claims to be included therein.

What is claimed is:

1. A two-way display device comprising:
a transparent display panel;
a roll film unit disposed opposite to the transparent display panel; and
a backlight unit disposed between the roll film unit and the transparent display panel.

2. The two-way display device of claim 1, further comprising:
a display panel driving circuit unit which drives the transparent display panel; and
a controller which controls the display panel driving circuit unit.

3. The two-way display device of claim 1, further comprising:
a roll film driving circuit unit which drives the roll film unit.

4. The two-way display device of claim 1, further comprising:
a light sensor which senses an intensity of illumination.

5. The two-way display device of claim 1, further comprising:
a light source driving circuit unit which drives the backlight unit.

6. The two-way display panel of claim 1, wherein the roll film unit comprises:
a film portion which displays an image; and
a roller which moves the film portion.

7. The two-way display panel of claim 6, wherein the film portion comprises an image region which displays a fixed image.

8. The two-way display panel of claim 7, wherein the film portion further comprises at least one of a transparent film region and a reflective film region.

9. The two-way display panel of claim 6, wherein the film portion comprises:
an image portion disposed in the middle of the film; and
a plurality of holes defined therein and arranged along a side of the film portion at predetermined intervals.

10. The two-way display panel of claim 6, wherein the roller comprises a plurality of protrusions disposed on an external surface of the roller at predetermined intervals.

11. The two-way display panel of claim 1, wherein the backlight unit comprises:
a light source disposed on a side of the backlight unit; and
a light guide plate which disperses light from the light source toward the transparent display panel and the roll film unit.

12. The two-way display panel of claim 11, wherein the backlight unit further comprises a plurality of optical sheets which disperses light emitted from the light guide plate.

13. The two-way display panel of claim 11, wherein the light source is a light emitting diode.

14. The two-way display panel of claim 11, wherein the light guide plate comprises a light dispersing agent.

15. The two-way display panel of claim 14, wherein the light dispersing agent comprises at least one selected from a cross-linkage or noncross-linkage particle of silicon, acryl, styrene, methyl methacrylate-styrene copolymer, polycarbonate, butylacrylate and olefin, silica, talc, calcium carbonate, barium sulfate and titanium dioxide.

16. A method of driving a two-way display device, the method comprising:
sensing surrounding light of the two-way display device, wherein the two-way display device comprises:
a transparent display panel;
a roll film unit disposed opposite to the transparent display panel; and
a backlight unit disposed between the roll film unit and the transparent display panel,
wherein the roll film unit comprises an image region, a transparent film region and a reflective film region;
analyzing the surrounding light to measure an intensity of illumination; and
disposing one of the image region, the transparent film region and the reflective film region to face the backlight unit based on the measured intensity of illumination by driving the roll film unit.

17. The method of claim 16, wherein the disposing one of the image region, the transparent film region and the reflective film region to face the backlight unit comprises disposing the transparent film region to face the backlight unit when the measured intensity of illumination is greater than a predetermined intensity.

18. The method of claim 16, further comprising:
driving the backlight unit to provide light to the transparent display panel and the roll film unit when the measured intensity of illumination is less than a predetermined intensity.

19. The method of claim 18, wherein the disposing one of the image region, the transparent film region and the reflective film region to face the backlight unit comprises disposing the image region to face the backlight unit when the measured intensity of illumination is less than the predetermined intensity.

20. The method of claim 18, wherein the disposing one of the image region, the transparent film region and the reflective film region to face the backlight unit comprises disposing the reflective film region to face the backlight unit when the measured intensity of illumination is less than the predetermined intensity.
